(19) United States
(12) Patent Application Publication
(10) Pub. No.: US 2026/0065075 A1
(43) Pub. Date: Mar. 5, 2026

(54) RECOMMENDATION PROCESS FOR RETRIEVAL-AUGMENTED GENERATION (RAG) MODELS

(71) Applicant: The Toronto-Dominion Bank, Toronto (CA)

(72) Inventors: Ilan Gofman, Toronto (CA); Alexander Clarence, Toronto (CA); Anuar Yeraliyev, Toronto (CA); Raunaq Suri, Mississauga (CA); Satya Krishna Gorti, Toronto (CA); Guangwei Yu, Toronto (CA); Maksims Volkovs, Toronto (CA)

(73) Assignee: The Toronto-Dominion Bank, Toronto (CA)

(21) Appl. No.: 18/817,519

(22) Filed: Aug. 28, 2024

(51) Int. Cl. G06N 3/0985

(52) U.S. Cl. CPC G06N 3/0985

(57) ABSTRACT

An example operation may include one or more of executing a retrieval augmented generation (RAG) model comprising a set of hyperparameters on input data to generate a predicted output via a software application, measuring runtime attributes of the RAG model based on at least one of execution of the RAG model on the input data and the predicted output, receiving a document that includes thresholds for the runtime attributes for the RAG model, executing an artificial intelligence (AI) model on the runtime attributes and the thresholds in the document to determine optimal hyperparameters for the RAG model, modifying the set of hyperparameters of the RAG model to include the optimal hyperparameters via the software application to generate a modified RAG model, and storing the modified RAG model within a model repository.

### BACKGROUND

Retrieval-augmented generation (RAG) is an emerging technology in which knowledge from a custom data source is leveraged to power predictive large language models (LLMs). RAG systems may operate in multiple stages including an offline ingestion stage in which documents are ingested, vectorized, and stored within a data store such as a vector database, and an online querying stage in which a query is input, and a response to the query is generated by the LLM. In the query stage, vectors related to the query (e.g., relevant context, history, knowledge, etc.) are retrieved from the vector database and used as input for the LLM. This helps the LLM to generate accurate predictions.

In both the offline ingestion stage and the online querying stage of the RAG system, the pipeline used to execute the RAG system can be complex, often involving multiple components that are costly to run. An abundance of solutions (e.g., hyperparameters, etc.) are available at both the individual component level and the pipeline level, however, very little development has been done to enable robust and consistent benchmarking of these solutions. Furthermore, the wide range of available components for design choices without consistent benchmarking of the components makes generating an efficient design a challenging task as users attempt to guess which components will be most effective in their design.

### SUMMARY

One example embodiment provides an apparatus that includes a memory which is communicably coupled to a processor, wherein the processor may one or more of execute a retrieval augmented generation (RAG) model comprising a set of hyperparameters on input data to generate a predicted output via a software application, measure runtime attributes of the RAG model based on at least one of the execution of the RAG model on the input data and the predicted output, receive a document that includes thresholds for the runtime attributes for the RAG model, execute an artificial intelligence (AI) model on the runtime attributes and the thresholds in the document to determine optimal hyperparameters for the RAG model, modify the set of hyperparameters of the RAG model to include the optimal hyperparameters via the software application to generate a modified RAG model, and execute the modified RAG model on a query to generate a response.

Another example embodiment provides a method that includes one or more of executing a retrieval augmented generation (RAG) model comprising a set of hyperparameters on input data to generate a predicted output via a software application, measuring runtime attributes of the RAG model based on at least one of the execution of the RAG model on the input data and the predicted output, receiving a document that includes thresholds for the runtime attributes for the RAG model, executing, an artificial intelligence (AI) model on the runtime attributes and the thresholds in the document to determine optimal hyperparameters for the RAG model, modifying the set of hyperparameters of the RAG model to include the optimal hyperparameters via the software application to generate a modified RAG model, and executing the modified RAG model on a query to generate a response.

A further example embodiment provides a computer readable storage medium comprising instructions, that when read by a processor, cause the processor to perform one or more of executing a retrieval augmented generation (RAG) model comprising a set of hyperparameters on input data to generate a predicted output via a software application, measuring runtime attributes of the RAG model based on at least one of the execution of the RAG model on the input data and the predicted output, receiving a document that includes thresholds for the runtime attributes for the RAG model, executing an artificial intelligence (AI) model on the runtime attributes and the thresholds in the document to determine optimal hyperparameters for the RAG model, modifying the set of hyperparameters of the RAG model to include the optimal hyperparameters via the software application to generate a modified RAG model, and executing the modified RAG model on a query to generate a response.

### BRIEF DESCRIPTION OF DRAWINGS

FIGS. 1A-1B are diagrams illustrating a computing environment for RAG system recommendations according to examples and features of the instant solution.

FIG. 2A is a system diagram illustrating integration of an AI model into any decision point according to the examples and features of the instant solution.

FIG. 2B is a diagram illustrating a process for developing an AI model that supports AI-assisted computer decision points according to the examples and features of the instant solution.

FIG. 2C is a diagram illustrating a process for utilizing an AI model that supports AI-assisted computer decision points according to examples and features of the instant solution.

FIG. 3A is a diagram illustrating a process of measuring latency attributes of a RAG system according to examples and features of the instant solution.

FIG. 3B is a diagram illustrating a process of measuring additional attributes of a RAG system according to examples and features of the instant solution.

FIG. 3C is a diagram illustrating a process of determining optimal hyperparameters for a RAG system using artificial intelligence according to examples and features of the instant solution.

FIGS. 4A-4B are diagrams illustrating a process of a user interacting with the recommendation system via a graphical user interface (GUI) according to examples and features of the instant solution.

FIG. 4C illustrates a process of executing the modified RAG model in response to a command from a client application according to examples and features of the instant solution.

FIGS. 5A-5B are diagrams illustrating a method of recommending components for a RAG model according to examples and features of the instant solution.

FIG. 6 is a system diagram illustrating a computing environment according to the instant solution's example features, structures, or characteristics.

### DETAILED DESCRIPTION

The examples and features of the instant solution are directed to an artificial intelligence (AI) based recommendation system that can automatically identify the most efficient components for a RAG system based on the performance of the RAG system, the goals of the RAG system, and the like. As such, the examples and features of the instant solution overcome the drawbacks (noted above) with the complexity of RAG systems and provide a technical solution by identifying the most efficient design components for a RAG system, for example, the most efficient hyperparameters for the RAG system, and integrating the hyperparameters into the RAG system for future execution.

As part of the process, the AI recommendation system may execute the RAG system to generate runtime performance data. For example, the AI recommendation system may measure latency of the different modules in the RAG system (e.g., ingestion, retrieval, post-processing, response generation, etc.). As another example, the AI recommendation system may measure other attributes such as precision, recall, relevance, correctness, and the like.

For example, the AI recommendation system may include its own large language model (LLM) which can receive attributes of the RAG system, such as runtime attributes of the RAG system, including latency attributes, precision attributes, recall attributes, relevance attributes, correctness attributes, and the like. In addition, the LLM may receive requirements of the RAG system, such as thresholds for one or more of latency, precision, recall, relevance, correctness, and the like. According to various examples and features of the instant solution, the LLM may automatically identify the most efficient hyperparameters of the RAG system to achieve the thresholds. The AI recommendation system may then modify the RAG system to include the hyperparameters.

Some of the technical benefits of the AI recommendation system include identifying components for a RAG system to achieve desired goals through the use of artificial intelligence. Other technical benefits include reducing the complexity which often comes with designing a RAG system because the AI recommendation system can sort through all possible/available options and identify the most efficient components for the RAG system under the circumstances. The AI recommendation system takes away the complexity of the design process and provides recommendations to perform the RAG task in an efficient manner that adheres to the goals of the RAG system.

By automatically recommending the most efficient hyperparameters for a RAG system, the examples and features of the instant solution can increase the efficiency of the design of the RAG system without the developer guessing and testing which components will be most efficient. Furthermore, the examples and features of the instant solution also ensure that all possible options can be considered in a very short period of time (e.g., a few seconds, etc.) which is something a human may have difficulty doing manually because the human executing the RAG system many different times with many different hyperparameter designs cannot produce results in a very short period of time and may take hours or even days.

The examples and features of the instant solution are directed to a recommendation system that is part of a framework that may standardize a RAG pipeline for benchmarking purposes, with a way for users (e.g., scientists and engineers, etc.) to benchmark their RAG systems for latency and performance metrics. The software may provide a graphical user interface (GUI) which enables the users to see the results and make decisions on which components and parameters of these components to use. In some cases, the recommendation system may automatically make the choices on behalf of the users.

In some cases, the recommendation system may use a set of benchmark metrics (e.g., latency, performance, etc.) which can be used to standardize how RAG performance is measured even when the RAG systems include different complex components, etc. In the examples and features of the instant solution, latency refers to how fast a certain component performs its tasks. Meanwhile, performance may refer to accuracy metrics, such as precision, recall, relevance, factual correctness, and the like. The system provides a way to compare the performance of a RAG system with different component implementations over a range of parameters. Furthermore, the framework enables interoperability and functionality that allows developers to integrate their custom components and run a suite of pre-defined benchmarking scripts for the purposes of analysis by the recommendation system.

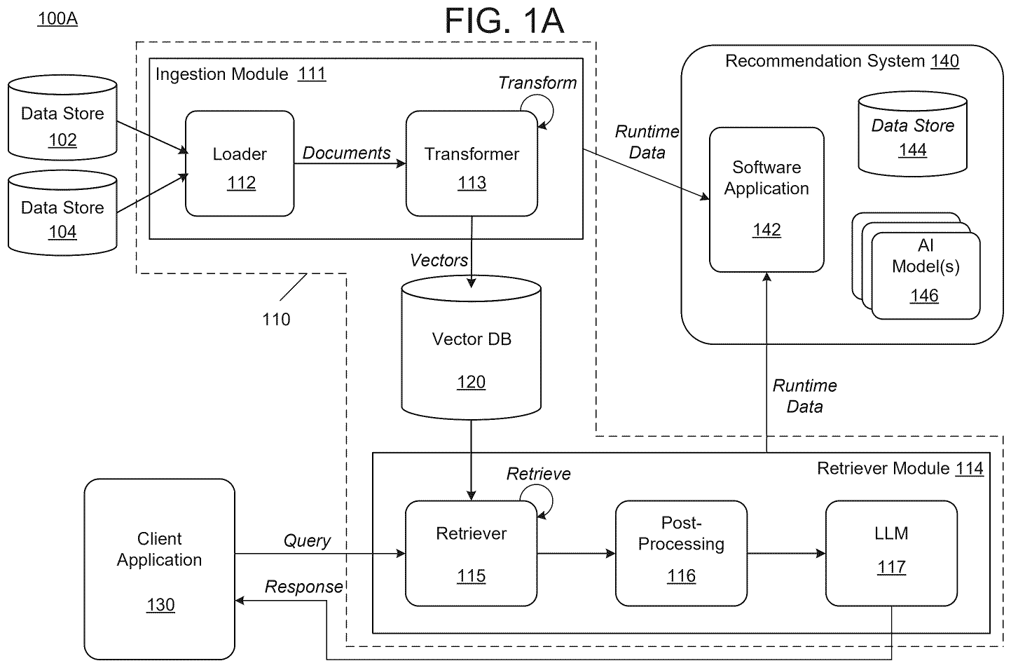

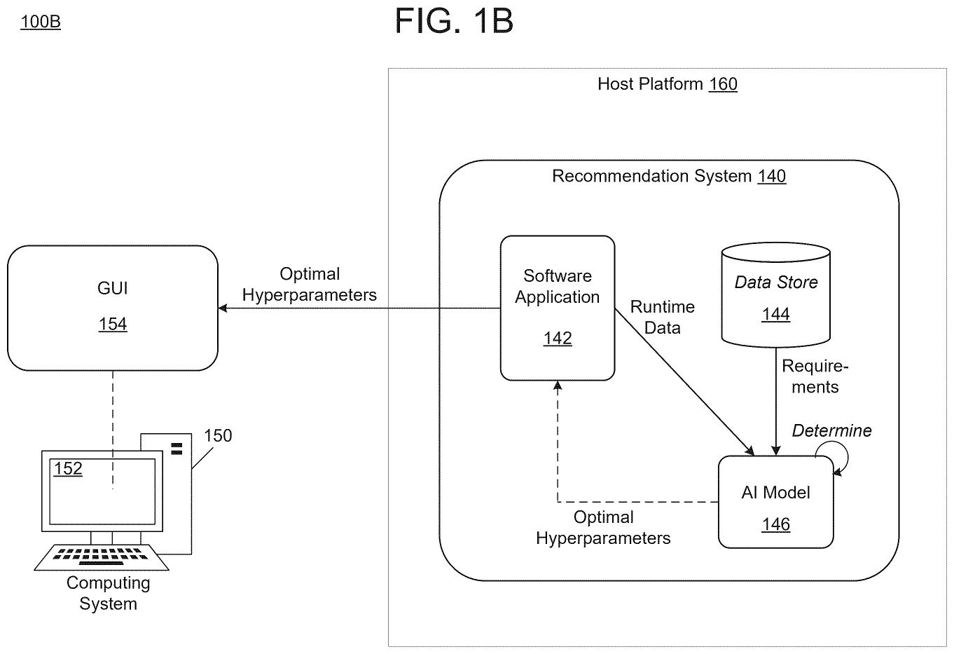

FIGS. 1A-1B illustrate a computing environment for RAG system recommendations according to examples and features of the instant solution. For example, FIG. 1A illustrates a process 100A of a recommendation system 140 capturing runtime attributes from a RAG system 110 according to examples and features of the instant solution. Referring to FIG. 1A, the RAG system 110 includes an ingestion module 111 and a retriever module 114. These modules are standard in RAG systems, however the individual components used to implement each of these modules can vary widely.

According to various examples and features of the instant solution, the ingestion module 111 may perform the task of ingesting data, such as documents, transforming the document data into vectors, and storing the vectors in a vector database 120. The ingestion module 111 may also perform indexing of the vectors within the vector database 120 to provide identification of the corresponding documents, etc. which correspond to the vectors. In some examples and features of the instant solution, the ingestion tasks may be performed offline, and not during the live runtime of the retriever module 114.

The ingestion module 111 may include a loader 112 which may load documents from at least one data store, such as a data store 102, a data store 104, etc. The data store 102 and the data store 104 may be document databases, file systems, or the like, and may include documents such as word processing documents, portable document format (PDF) documents, extensible markup language (XML) documents, JavaScript Object Notation (JSON) documents, spreadsheets, and the like. The loader 112 may execute a script that can retrieve documents from memory addresses within the data store 102 and/or the data store 104 and transfer the documents to a transformer 113.

The transformer 113 may convert the documents into vectors and store the vectors within the vector database 120. The conversion process may include tokenizing the documents into tokens, chunking the documents into chunks of tokens, converting each chunk to a vector, and storing the vectors in the vector database. As an example, a document may be converted into hundreds or even thousands of tokens. Meanwhile, the chunking process may aggregate a predefined number of tokens (e.g., 100, 150, 250, etc.) into a chunk. Each chunk may then be converted into a corresponding vector. In some examples and features of the instant solution, the transformer 113 may index the vectors within the vector database 120 and add labels and other metadata that identifies attributes of the vectors, such as an identifier of the corresponding document, a type of document data, and the like.

According to various examples and features of the instant solution, the retriever module 114 may be executed in response to a query from a client application 130. For example, the client application 130 may submit a question or other natural language input which is transmitted to a retriever 115. In response, the retriever 115 may convert the query into a vector and compare the vector to the vectors already stored in the vector database 120 to identify a subset of vectors that are related to the query. The retriever 115 may retrieve the subset of vectors and transfer them to a post-processing module 116 which can clean the subset of vectors, perform deduplication, and the like. The post-processing module 116 may transfer the cleaned subset of vectors along with the query vector to a large language model (LLM) 117 which generates a response to the query.

In this example, the LLM 117 may generate a response to the query based on the query vector and the subset of vectors that have been retrieved from the vector database 120. The response may be a natural language response that can be output to the client application 130. The retriever module 114 may be referred to as an online module because the steps may be performed in response to a live query from the client application 130, such as from a user device that is network-connected to a host platform that hosts the RAG system 110.

According to various examples and features of the instant solution, a recommendation system 140 (that may also be hosted on the host platform or a network-connected platform) may monitor the performance of the RAG system 110 during both the ingestion stage and the query stage. For example, the recommendation system 140 may include a software application 142 that receives runtime data from the ingestion module 111 during the document data ingestion processes. In addition, the software application 142 may receive runtime data from the retriever module 114 during query/response processes. The runtime data may include latency measurements, accuracy/performance measurements, and the like.

In addition, the recommendation system 140 may include a data store 144 which stores goals of the RAG system 110. The goals may include thresholds for latency, accuracy, etc. and may be provided by a developer, input through a GUI of the software application 142, or the like. The recommendation system 140 may also include an AI model 146, such as an LLM which is configured to receive the runtime data (e.g., latency attributes, accuracy attributes, etc.) and the goals of the RAG system 110, and determine optimal components for the RAG system 110 including hyperparameters of the RAG system 110. In some cases, the recommendation system 140 may display the optimal hyperparameters via a GUI of the software application 142 and receive confirmation of the optimal hyperparameters. In response, the software application 142 may modify the RAG system 110 to include the optimal hyperparameters. As another example, the recommendation system 140 may automatically modify the hyperparameters of the RAG system 110 to include the optimal hyperparameters without user confirmation.

Examples of hyperparameters for a RAG system include a chunking size of the ingestion module, a chunking type used, an embedding module (for transforming document data into embeddings), retrieval parameters to be used by the retrieving module, number of search results/vectors to retrieve (top k), an LLM to use for response generation, and the like. These hyperparameters can vary widely as many different options are possible. In the examples and features of the instant solution, the recommendation system 140 includes an AI model 146 (such as an LLM) that is trained to recommend a most optimal set of hyperparameters for a RAG system. The AI model 146 may be trained on the details of known/historical RAG systems including tasks performed by the RAG systems, model components, goals/requirements of the RAG systems, and the like.

FIG. 1B illustrates a process 100B of the software application 142 of the recommendation system 140 outputting the optimal hyperparameters via a graphical user interface (GUI) 154 of the software application. Referring to FIG. 1B, the recommendation system 140 is hosted by a host platform 160, such as a cloud platform, a web server, a combination of systems, and the like. Here, the host platform may include at least one processor, multiple processors, and the like. In some examples and features of the instant solution, the host platform 160 may also host the RAG system 110 shown in the example of FIG. 1A.

A user may connect to the recommendation system 140 by connecting to the host platform 160 over a computer network. In this example, the user may use a computing system 150 to connect to the host platform 160, for example, by inputting a web address of the software application 142 into a browser of the computing system 150. As another example, the computing system 150 may host a front-end of the software application 142 that is able to connect to a back-end of the software application 142 at the host platform 160. The software application 142 may output a GUI 154 which may be displayed on a display device 152 of the computing system 150.

According to various examples and features of the instant solution, the optimal hyperparameters generated by the AI model 146 may be output to the GUI 154 via the software application 142. In some examples and features of the instant solution, the user may confirm inclusion of the optimal hyperparameters by inputting commands to the GUI 154. As another example, the user may request an additional iteration of performance be generated for the RAG system by requesting the RAG system execute another iteration on test data, etc.

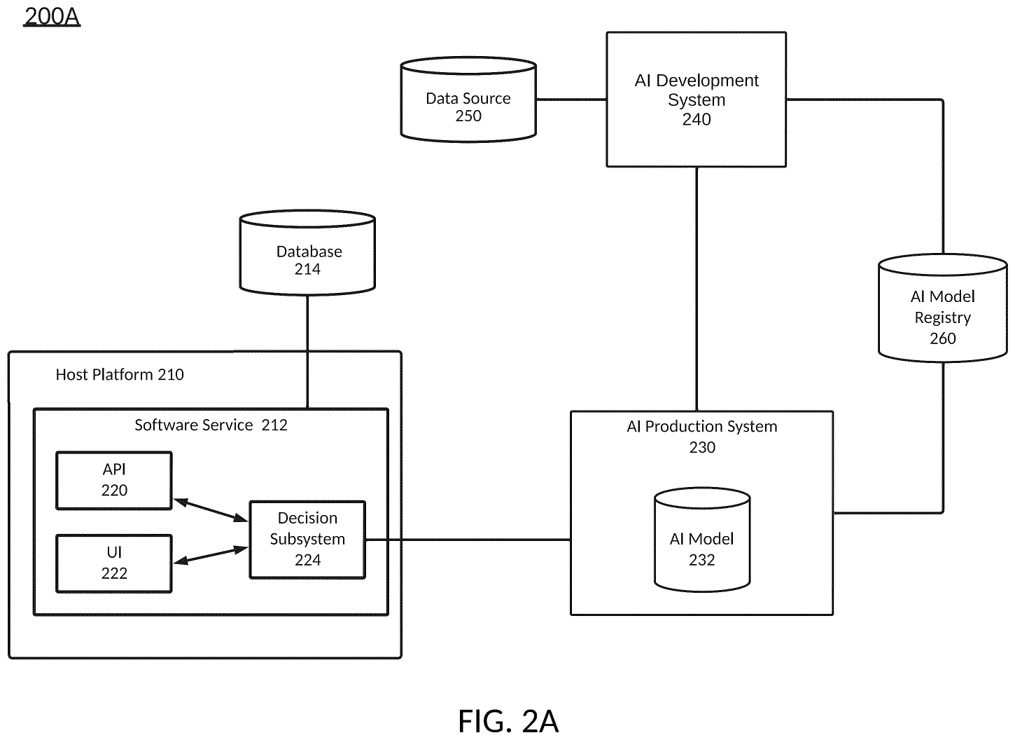

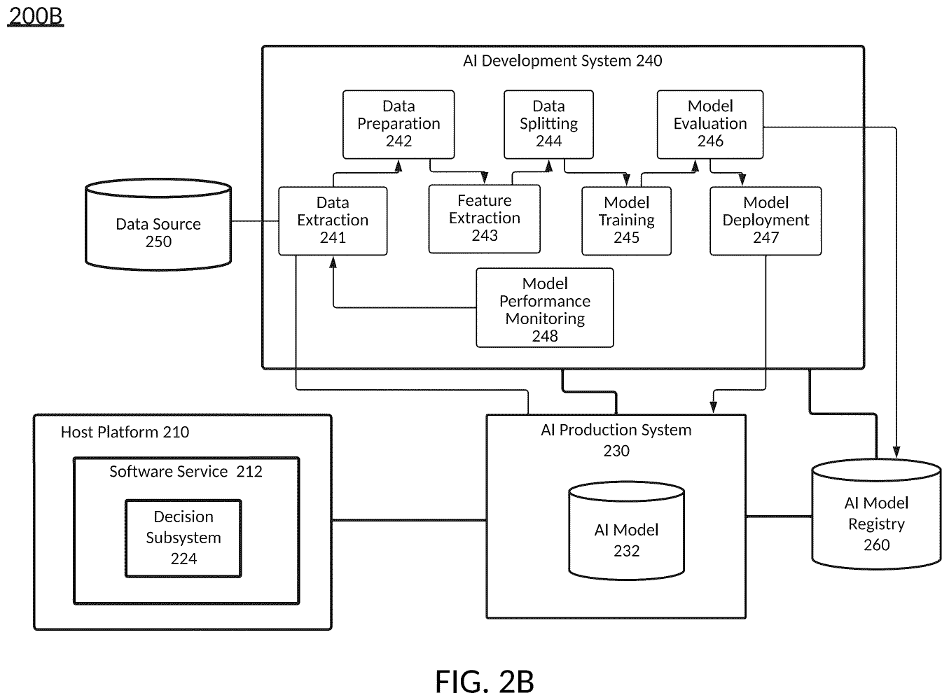

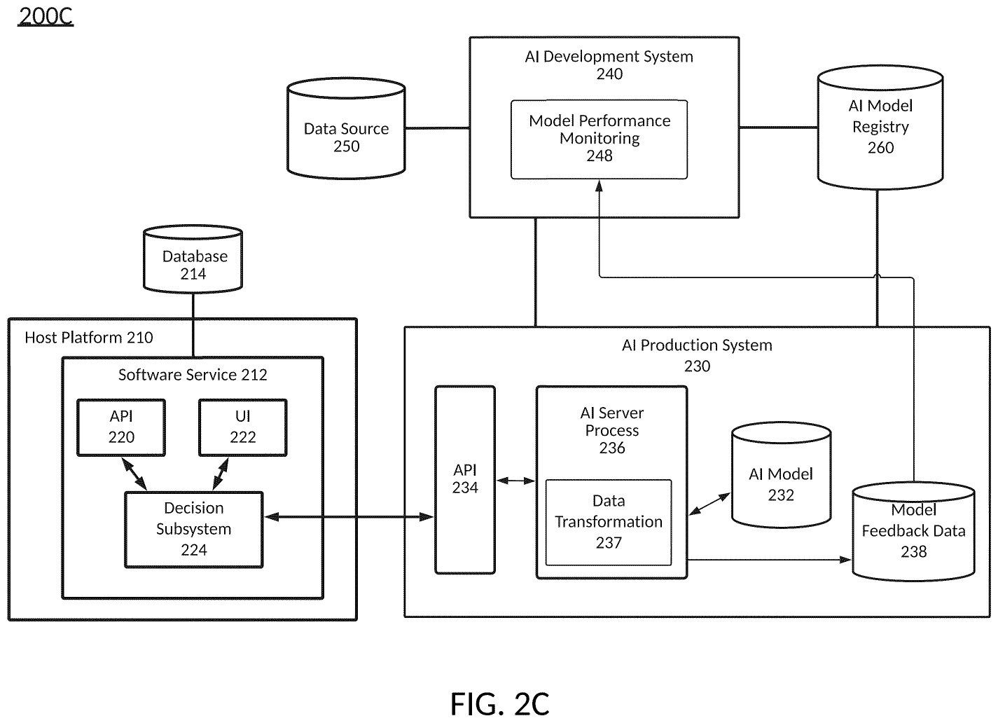

The AI model(s) described herein may be pre-trained, trained, re-trained, fine-tuned, and the like. FIGS. 2A-2C are diagrams illustrating examples of processes for training and deploying an AI model that may apply to the AI models described herein including the AI models of the recommendation system.

Furthermore, in some examples of the instant solution, AI model(s) 146 depicted with respect to FIGS. 1A-1B may reside separately from the software application 142 which uses it, such as in the process described with respect to FIGS. 2A-2C. In some examples of the instant solution, AI model(s) 146 may be examples of AI model 232 described and depicted in FIGS. 2A-2C. In some examples of the instant solution, software application 142 may be an example of software service 212, described and depicted in FIGS. 2A-2C. In some examples of the instant solution, vector database 120 and data store 102, 104, and 144 may be an example of data source 250 or database 214, described and depicted in FIGS. 2A-2C. In some examples of the instant solution, the AI model 146 may be deployed to an AI production system where the software application 142 on the host platform 160 may access and execute it. In some examples of the instant solution, the RAG system 110 and the recommendation system 140 may be deployed to an AI production system 230, described and depicted in FIGS. 2A-2C. In some examples of the instant solution, the host platform 160 may be an example of host platform 210 described and depicted in FIGS. 2A-2C, or the host platform 160 may be a combination of systems that includes host platform 210, AI development system 240, and AI production system 230, as described and depicted in FIGS. 2A-2C.

FIG. 2A illustrates an artificial intelligence (AI) network diagram 200A that supports AI-assisted decision points in a software service executing on a computer. One or more computing devices and a host platform 210 may communicate via a network. The host platform 210 may host a software service 212. The software service 212 may communicate with one or more databases 214 through a network during the course of service execution. In some examples and features of the instant solution, a computing device may host a service client which communicates with a corresponding software service 212.

A computing device may be a mobile phone, tablet, laptop computer, desktop computer, smartwatch, vehicle infotainment system, or any computing device including a processor and memory. The host platform 210 may include a single physical server, multiple physical servers, a cloud hosting environment, or a hybrid hosting environment in which some components of the host platform 210 are “on-premise” while others are cloud-hosted. The network is a computer network and may include one or more interconnected computer networks. For example, network may be or may include an Ethernet network, an asynchronous transfer mode (ATM) network, a wireless network, a telecommunications network or the like.

The software service 212 provides the service logic. It may provide one or more Application Programming Interfaces (APIs) for communicating with one or more service clients. A “thick” user interface client that runs on a computing device may utilize the APIs to communicate with the software service 212. Further, the software service 212 may provide hosted User Interfaces (UIs) that can be accessed through browser-based software on some computing devices.

The one or more service clients can enable service access for end users and may come in a variety of forms including, but not limited to, a mobile device application (“app”) or a web portal accessed via a browser on a computing device such as a laptop or desktop computer.

While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised, unsupervised, and reinforcement learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, increasing its accuracy for performing high speed data classifications, clustering, and other analyses of data. Such neural network capabilities are the foundation of deep learning models today as well as becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities relies on the fundamentals of generative AI. Furthermore, in an evolution into the self-aware classification, AI models will be able to understand and evoke emotions in the entities they interact with, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

In the example of FIG. 2A, the software service 212 executing on host platform 210 may provide one or more application programming interfaces (APIs) 220 that enable interaction with other software components via a set of data definitions and protocols. In some examples and features of the instant solution, the APIs provided may employ Simple Object Access Protocol (SOAP), Remote Procedure Calls (RPC), and Representational State Transfer (REST) techniques. In some examples and features of the instant solution, the plurality of APIs 220 send data to one or more decision subsystems 224 of the software service 212 to assist in decision-making. In some examples and features of the instant solution, the software service 212 stores data included in API requests or data generated during processing the API requests into one or more databases 214.

Software service 212 may provide one or more user interfaces (UIs) 222, such as a server-side hosted graphical user interface (GUI). In some examples and features of the instant solution, the UIs 222 provided employ template-based frameworks, component-based frameworks, etc. In some examples and features of the instant solution, these UIs 222 send data to one or more decision subsystems 224 of the software service 212 to assist with decision-making. In some examples and features of the instant solution, the software service 212 stores data included in UI requests or data generated during processing the UI requests into one or more databases 214.

Software service 212 may include one or more decision subsystems 224 that drive a decision-making process of the software service 212. In some examples and features of the instant solution, the decision subsystems 224 receive data from one or more APIs 220 as input into the decision-making process. In some examples and features of the instant solution, a decision subsystem 224 may receive data from one or more UIs 222 as input to the decision-making process. A decision subsystem 224 may gather service configuration or historical execution data from one or more databases 214 to aid in the decision-making process. A decision subsystem 224 may provide feedback to an API 220 or a UI 222.

An AI production system 230 may be used by a decision subsystem 224 in a software service 212 to assist in its decision-making process. The AI production system 230 includes one or more AI models 232 that are executed to generate a response, such as, but not limited to, a prediction, a categorization, a UI prompt, etc. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

An AI development system 240 creates one or more AI models 232. In some examples and features of the instant solution, the AI development system 240 utilizes data from one or more data sources 250 to develop and train one or more AI models 232. The data sources 250 may be local or third-party data sources. Further, the data provided by the data sources may be real-world or synthetic. In some examples and features of the instant solution, the AI development system 240 utilizes feedback data from one or more AI production systems 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

Once an AI model 232 has been trained and validated in the AI development system 240, it may be stored in an AI model registry 260 for retrieval by either the AI development system 240 or by one or more AI production systems 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing one or more AI models that support AI-assisted decision points. An AI development system 240 executes steps to develop an AI model 232 that begins with data extraction 241, in which data is loaded and ingested from one or more data sources 250. In some examples and features of the instant solution, historical model feedback data is extracted from one or more AI production systems 230.

Once the data has been extracted during data extraction 241, it undergoes data preparation 242 for model training. In some examples and features of the instant solution, this step involves statistical testing of the data to see how well it reflects real-world events, its distribution, the variety of data in the dataset, etc., and the results of this statistical testing may lead to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 242 may be a manual process or an automated process using one or more of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using one or more of the elements and/or functions described and/or depicted herein. Once the features have been identified, the values of the features are collected into a dataset that will be used to develop the AI model 232.

The dataset output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The performance of the AI model 232 is then tested within the AI development system 240 utilizing the validation data set from step 244. These steps may be repeated with adjustments to one or more algorithm parameters until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. In some examples and features of the instant solution, one or more unseen validation datasets are used. In some examples and features of the instant solution, the staging environment is part of the AI development system 240, and the staging environment is managed separately from the AI development system 240. Once the AI model 232 has been validated, it is stored in an AI model registry 260, where it can be retrieved for deployment and future updates. In some examples and features of the instant solution, the model evaluation step 246 may be a manual process or an automated process using one or more of the elements and/or functions described and/or depicted herein.

In some examples and features of the instant solution, the AI development system includes a user interface (not shown). The user interface may be used to manage the development system infrastructure, the steps 241-248 within the development system, the interim data transmitted between the various steps 241-248, and the data sources 250.

Once an AI model 232 has been validated and published to an AI model registry 260, it may be deployed during the model deployment step 247 to one or more AI production systems 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes one or more triggers that result in the AI model 232 being updated by repeating steps 241-248 with updated data from one or more data sources 250.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, an AI production system 230 may be used by a decision subsystem 224 in software service 212 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 212, UI 222 data from software service 212 or data from other software service 212 subsystems (not shown).

Upon receiving the API 234 request, the AI server process 236 may transform 237 the data payload or portions of the data payload to be valid feature values in an AI model 232. Data transformation 237 may include, but is not limited to, combining data values, normalizing data values, and enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 212. In some examples and features of the instant solution, the response may result in an update to a UI 222 in software service 212. In some examples and features of the instant solution, the response includes a request identifier that can be used later by the software service 212 to provide feedback on the performance of the AI model 232. In some examples and features of the instant solution, a model feedback record may be added into a model feedback data 238 by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

In some examples and features of the instant solution, the AI production system 230 includes a user interface (not shown). The user interface may be used to manage the production system infrastructure, the components of the production system 230-238, and the operation of the AI production system and its components.

According to various examples and features of the instant solution, an artificial intelligence operational pipeline (e.g., an AI pipeline) may be used to train an AI model by executing the AI model on training data. The AI pipeline may include various modules, nodes, etc. which perform various tasks of the AI pipeline. The tasks may be executed in sequence. As another example, the tasks may be executed in parallel. In addition to training an AI model, the AI pipeline may be used to perform an inference (e.g., generate a predictive output) by executing the AI model on input data.

According to various examples and features of the instant solution, the AI pipeline may validate the training data, the input data, the output data, and the like. For example, when the input data is determined to be invalid, the software may pause/stop the AI pipeline and flag a location (e.g., a point in the process, etc.) at which the process is paused/stopped. Furthermore, the software may replace or otherwise fix the invalid data with valid data and resume the AI pipeline from the flagged location in the process.

The examples that are shown in FIGS. 2A-2C may be used to train and/or execute the AI models described herein such as at least one AI model used by the recommendation system described according to various examples and features of the instant solution. The training process may be used to train the at least one AI model to generate recommendations to model parameters/hyperparameters based on at least one of performance attributes of the at least one AI model, requirements of the at least one AI model, goals of the at least one AI model, and the like.

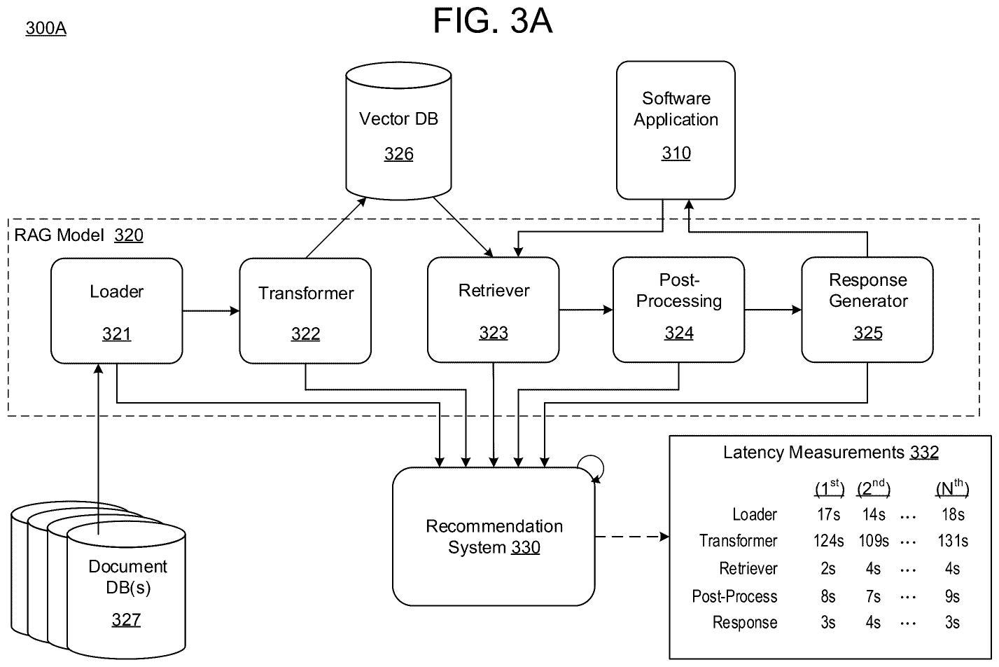

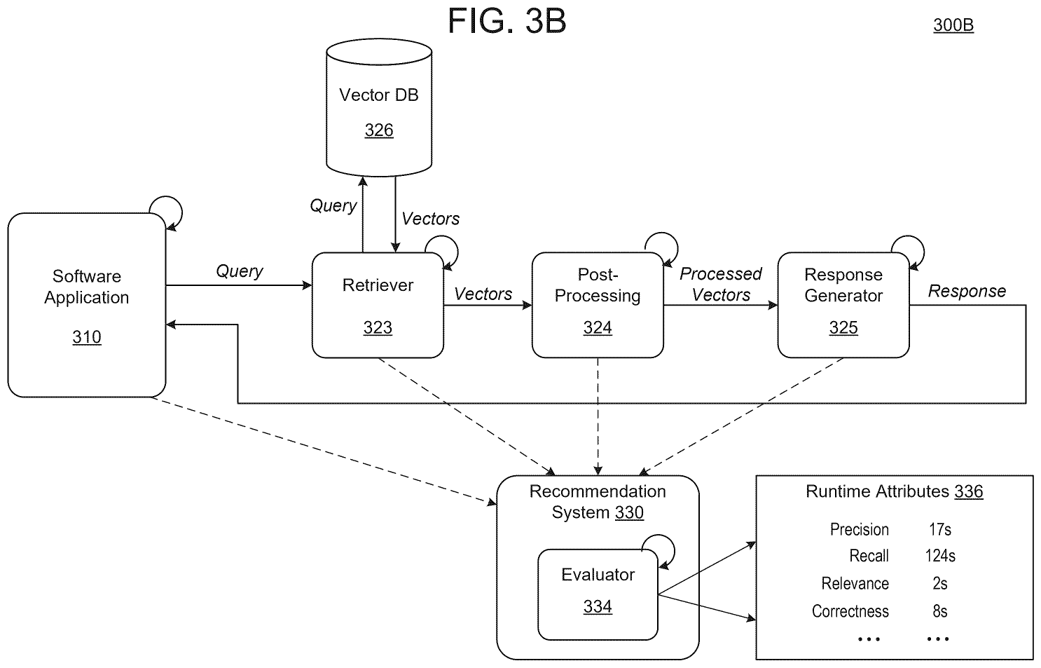

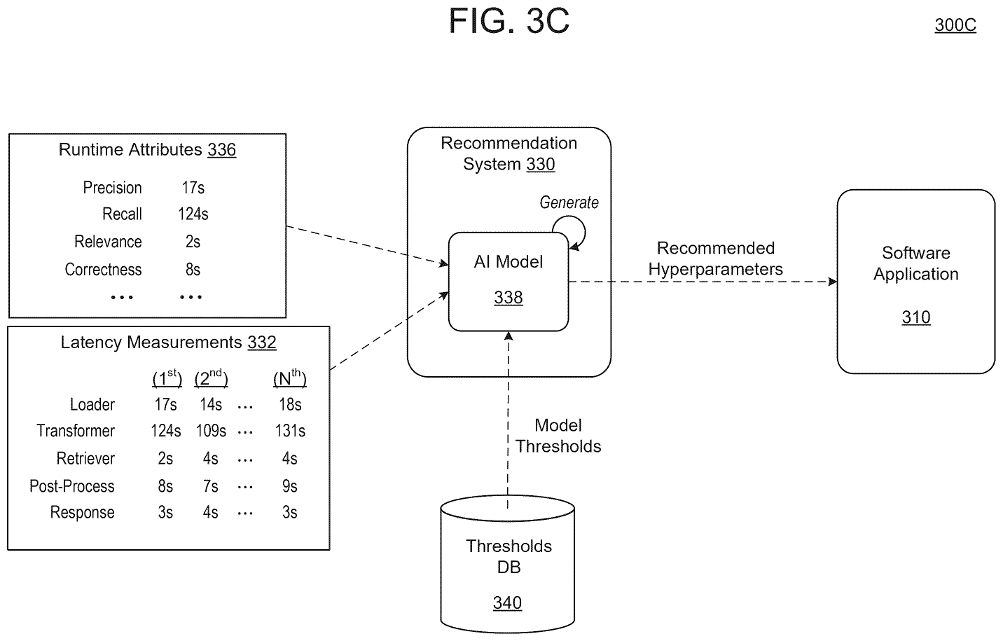

FIG. 3A illustrates a process 300A of measuring latency attributes of a RAG model 320 according to examples and features of the instant solution. Referring to FIG. 3A, the RAG model 320 may include a loader module 321, a transformer module 322, a retriever module 323, a post-processing module 324, and a response generator module 325 such as an LLM. In the example of FIG. 3A, the loader module 321 may ingest documents from one or more document databases 327 and transfer the documents to the transformer module 322. In response, the transformer module 322 may convert the documents into vector embeddings based on various hyperparameters such as chunk size, chunking method, vectorization model type, etc. and store the vector embeddings with a vector database 326.

A software application 310 may query the RAG model 320 with a natural language input. For example, the retriever module 323 may receive a query, such as a question, etc., from the software application 310, vectorize the query, and identify one or more vectors in the vector database 326 that are related to the vectorized query, retrieve the one or more vectors, and forward the one or more vectors and the vectorized query to a post-processing module 324. Here, the post-processing module 324 may process the vectors to remove duplicates, rank the vectors, filter the vectors, etc. and input the one or more vectors and the vectorized query to the response generator module 325. The response generator module 325 may generate a response to the query (e.g., based on execution of an LLM, etc.) and return the response to the software application 310.

During operation of the RAG model 320, a recommendation system 330 may measure runtime attributes of the RAG system including latency of each of the components including the loader module 321, the transformer module 322, the retriever module 323, the post-processing module 324, and the response generator module 325. Here, the latency refers to the time it takes each module to perform its task. The latency values may be stored in a table of latency measurements 332. Each iteration of the RAG model 320 may generate another round of measurements of the latency for each of the components in the RAG model 320.

FIG. 3B illustrates a process 300B of measuring additional attributes of the RAG model 320 according to examples and features of the instant solution. Referring to FIG. 3B, the RAG model 320 may execute a test using an evaluation data set. Here, the recommendation system 330 may include an evaluator 334 that is configured to determine various metrics (e.g., runtime attributes) based on the performance of the RAG model 320 when executing the test. For example, the evaluator 334 may determine a precision metric of the RAG model 320, a recall metric, a relevance metric, a correctness metric, and the like. The evaluator 334 may generate a table with the runtime attributes 336.

FIG. 3C illustrates a process 300C of determining optimal hyperparameters for the RAG model 320 using artificial intelligence according to examples and features of the instant solution. Referring to FIG. 3C, the recommendation system 330 may further include an AI model 338, such as an LLM which is trained to determine optimal hyperparameters for the RAG model 320 based on historical RAG models, hyperparameters of those RAG models, latency values of those RAG models, performance attributes (precision, recall, relevance, correctness, etc.) of those RAG models, and the like. The AI model 338 is trained to determine optimal hyperparameters for a RAG model given performance attributes and requirements of the RAG models. The requirements may specify thresholds for latency, precision, recall, relevance, etc.)

In the example of FIG. 3C, the AI model 338 may receive, as input, the table of latency measurements 332 of the components of the RAG model 320, the table of runtime attributes 336 of the RAG model 320, and thresholds for one or more of latency and performance, and generate optimal hyperparameters that are then output to the software application 310. For example, the thresholds may be provided from a threshold database 340. The optimal hyperparameters may be different than the current hyperparameters of the RAG model 320. Here, the software application 310 may modify the RAG model 320 to include the optimal hyperparameters.

In some examples of the instant solution, RAG model 320 and recommendation system 330 may be deployed in an AI production system 230, as described and depicted in FIGS. 2A-2C. In some examples of the instant solution, AI model 338 may be an example of AI model 232, described and depicted in FIGS. 2A-2C. In some examples of the instant solution, software application 310 may be an example of software service 212, described and depicted in FIGS. 2A-2C. In some examples of the instant solution, document databases 327, vector database 326, and thresholds database 340 may be examples of data source 250 or database 214, described and depicted in FIGS. 2A-2C.

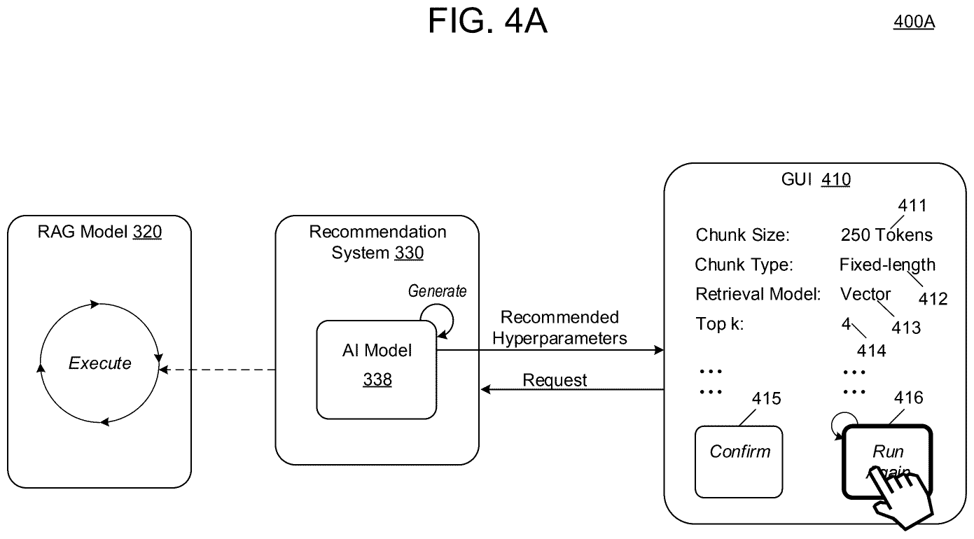

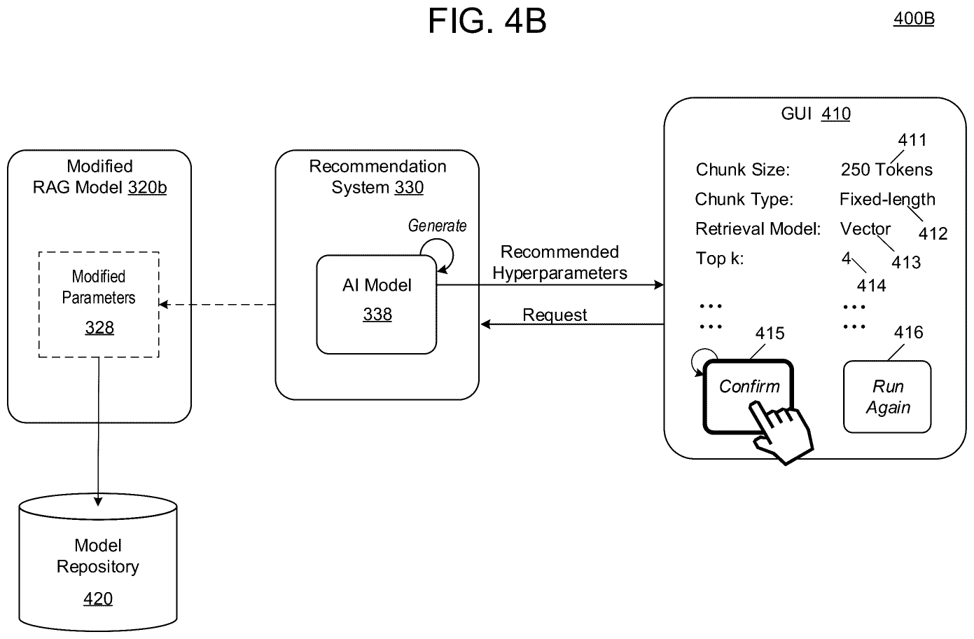

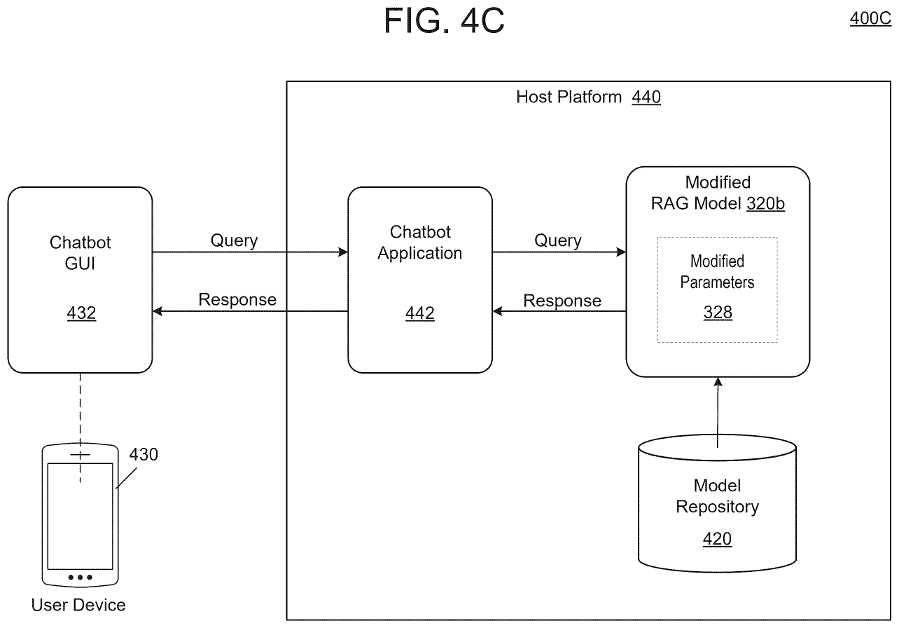

FIGS. 4A-4B illustrate a process of a user interacting with the recommendation system via a graphical user interface (GUI) according to examples and features of the instant solution. For example, FIG. 4A illustrates a process 400A of a user inputting commands on a GUI 410 to cause an additional iteration of a RAG model 320 according to examples and features of the instant solution. Referring to FIG. 4A, the recommendation system 330 shown in FIG. 3C, may output the optimal hyperparameters of the RAG model 320 that are generated by the AI model 338 to the GUI 410. For example, the recommendation system 330 may use a software application or the like to output the recommended optimal hyperparameters to the GUI 410.

In this example, the optimal hyperparameters include a first hyperparameter 411 related to chunk size that is used by the ingestion module to chunk documents, a second hyperparameter 412 that is used by the ingestion module to chunk documents, a third hyperparameter 413 which is used by the retriever module to retrieve documents from a vector database, and a fourth hyperparameter 414 which identifies how many vectors to be retrieved from the vector database by the retriever. These are just examples of hyperparameters and are not meant to limit the optimal hyperparameters that may be determined by the AI model 338.

The GUI 410 also includes a confirm button 415 and a run again button 416. Here, the confirm button 415, when pressed, integrates the optimal hyperparameters determined by the AI model 338 into the RAG model 320. As another example, the run again button 416, when pressed, causes the RAG model 320 to be executed again on an evaluation set (test) of input data to determine additional latency attributes and metrics and to determine the optimal hyperparameters again. In this example, the user presses the run again button 416. In response, the recommendation system 330 may trigger execution of the RAG model 320 on another round of evaluation data which may also be chosen via the GUI 410 with controls that are not shown. In response, additional runtime attributes (e.g., latency attributes, performance attributes, etc.) of the RAG model 320 may be measured and used to generate a new recommended optimal hyperparameters by the recommendation system 330.

Meanwhile, FIG. 4B illustrates a process 400B of the user inputting commands on the GUI 410 to confirm the optimal hyperparameters that are displayed on the GUI 410 including the first hyperparameter 411, the second hyperparameter 412, the third hyperparameter 413, and the fourth hyperparameter 414. In response, the recommendation system 330 may incorporate or otherwise integrate the optimal hyperparameters into the RAG model 320. For example, the recommendation system 330 (software application thereof) may replace existing hyperparameters with the optimal hyperparameters to thereby generate modified hyperparameters 328. The result is a modified RAG model 320b.

The modification may be performed without a user making such changes manually. Instead, the software may automatically replace the existing hyperparameters of the RAG model 320 with the optimal hyperparameters determined by the AI model 338 during execution. Furthermore, the modified RAG model 320b may be stored within a model repository 420.

FIG. 4C illustrates a process 400C of executing the modified RAG model 320b in response to a command from a client application according to examples and features of the instant solution. Referring to FIG. 4C, a host platform 440 hosts a chatbot application 442 that is configured to generate natural language responses to natural language queries. In this example, a user may use a user device 430 to connect to the host platform 440 via a computer network. In response, the user device 430 may receive a GUI 432 of the chatbot application 442 served from the host platform 440. Here, the GUI 432 may enable the user to input a query which is transferred to the chatbot application 442 by the GUI 432.

In response to receiving the query from the user, the chatbot application 442 may query the modified RAG model 320b and request a response from the modified RAG model 320b. In response, the modified RAG model 320b may receive the query and generate a natural language response to the query and return the natural language response to the GUI 432 via the chatbot application 442. In this example, the modified RAG model 320b may use the modified hyperparameters 328 (i.e., the optimal hyperparameters determined by the AI model 338) to generate the natural language response. In this case, the natural language response may be more accurate, execute with less latency, etc., with respect to the original RAG model 320, as a result of the modified hyperparameters 328.

In some examples of the instant solution, RAG model 320, modified RAG model 320b and recommendation system 330 may be deployed in an AI production system 230, as described and depicted in FIGS. 2A-2C. In some examples of the instant solution, AI model 338 may be an example of AI model 232, described and depicted in FIGS. 2A-2C. In some examples of the instant solution, chatbot application 442 may be an example of a combination of software service 212 with AI model 232, described and depicted in FIGS. 2A-2C. In some examples of the instant solution, model repository 420 may be an example AI model registry 260, described and depicted in FIGS. 2A-2C.

In one example of the instant solution, one or more reference data sources are retrieved, via the ingestion module, which loads and transforms data from various document stores into vectors stored within a vector database. These vectors represent the reference data sources within an embedding space aligned with the AI model. Upon receiving a query from the application, the system's retriever module (see, for example, system process 100A and retriever module 115 of FIG. 1A, system processes 300A/300B and retriever module 323 of FIGS. 3A-3B) processes the query by converting it into a vector within the same embedding space. The query vector is then compared against the stored vectors of the reference data sources. This comparison enables the determination of a ranking order based on relevance or other predefined metrics managed by the AI-based recommendation system.

Once the closest-matching reference data source is identified, the AI model, optimized with the most relevant hyperparameters, is executed on the query. The AI model generates a response by using the reference data that ranked highest in relevance. This response is returned to the application through the application interface, ensuring the response is contextually appropriate and efficiently generated.

The system continuously optimizes and refines its components, including the AI model, through iterative benchmarking and hyperparameter adjustments, ensuring efficient and accurate operation.

In another example of the instant solution, a trained AI model is retrieved through the system's ability to access and utilize pre-trained models stored within an AI model registry (see, for example, system processes 200B/200C and AI model registry 260 of FIGS. 2B-2C, system processes 400B/400C and model repository 420 of FIGS. 4B-4C). The system retrieves a ranking model trained on one or more reference data sources. This ranking model is designed to evaluate the relevance of different data sources concerning specific queries.

Upon receiving a query from the application, the system uses the ranking model to assess the query against the available reference data sources. The ranking model compares the query's embedding within the context of the reference data sources, determining which source provides the closest match. This process is enabled by the system's retrieval and post-processing modules, which ensure that the most relevant data is identified and ranked accordingly. When the closest match is determined, the AI model is executed on this top-ranked query response. This execution generates a response that accurately addresses the application's query by integrating the most relevant information from the closest-matched reference data source. The response generated by the AI model is then returned to the application, ensuring that the output is precise and contextually aligned.

The AI-based recommendation system (see, for example, recommendation system 140 of FIGS. 1A-1B and recommendation system 330 of FIGS. 3A-3C, 4A-4B) and associated functionality disclosed herein provides a technical solution to the inherent complexities and inefficiencies associated with designing and operating RAG models used in AI-based applications. Traditional RAG models often suffer from suboptimal performance due to the vast array of hyperparameters and component configurations that are manually tuned, leading to increased latency, reduced accuracy, and overall inefficiency. The instant solution addresses these challenges by introducing an AI-based recommendation system that autonomously identifies and implements the most effective hyperparameters and component configurations for a given RAG model.

This system enhances the functionality of RAG models by continuously monitoring runtime attributes, such as latency, precision, recall, and relevance during both the data ingestion and query response stages. By using these real-time performance metrics, the recommendation system can dynamically adjust the RAG model's hyperparameters, ensuring that the model operates with efficiency. This automated process eliminates manual tuning, which is often time-consuming and error-prone, thereby reducing computational overhead and response times.

Moreover, the AI-based recommendation system combines real-time data processing with advanced AI techniques to solve specific technical problems inherent in RAG systems which includes optimizing the interaction between various modules, such as the retriever, transformer, and response generator, based on the context of the specific queries and reference data sources involved.

This engine can rapidly identify the most effective hyperparameter configurations for a given scenario, significantly reducing the trial-and-error process typically associated with manual tuning. Unlike conventional methods that rely on static or heuristic-based optimization, this system provides a novel approach by learning from prior model executions and continuously refining its recommendations, thereby delivering increased performance with less computational overhead.

The system is designed to support this interaction by allowing real-time feedback between the AI model and ranking models. For example, when the initial query results in a less accurate response, the AI model can signal the ranking model to adjust its parameters or re-evaluate the relevance of different data sources. This continuous feedback loop, enabled by the underlying algorithms, ensures that each subsequent query benefits from the refinements made during previous iterations, leading to progressively more accurate and contextually relevant responses.

In addition, the specific algorithms in this system are optimized for parallel processing, allowing both the ranking models and AI models to operate simultaneously and interactively without delays. This parallelism is supported by recent advancements in AI and machine learning frameworks, which have demonstrated the effectiveness of real-time model integration in increasing system performance. These frameworks provide the computational foundation that allows the system to execute complex interactions between the ranking models and AI models efficiently, distinguishing the instant solution from existing ones that are relying on linear, less interactive processes.

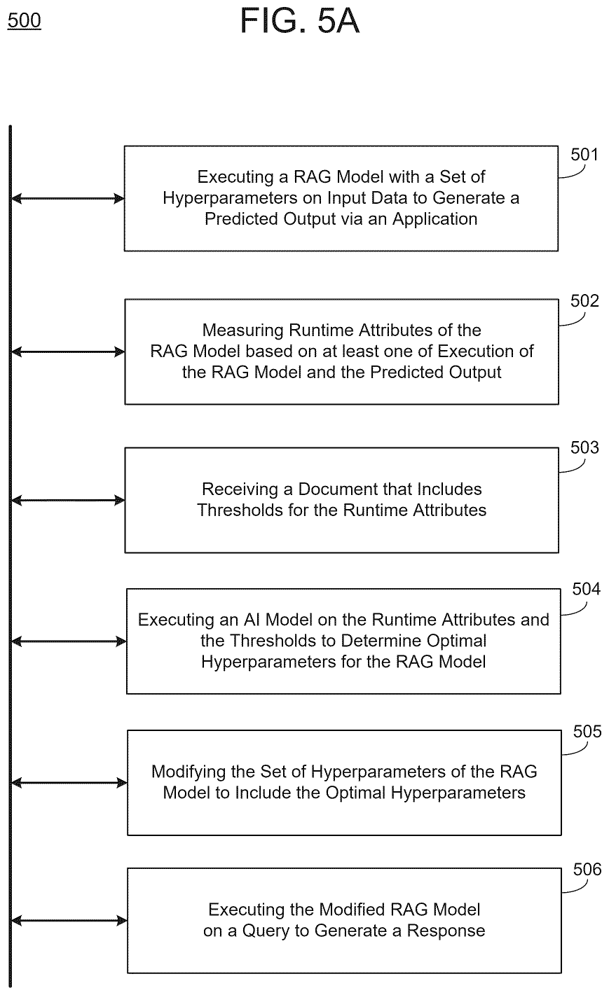

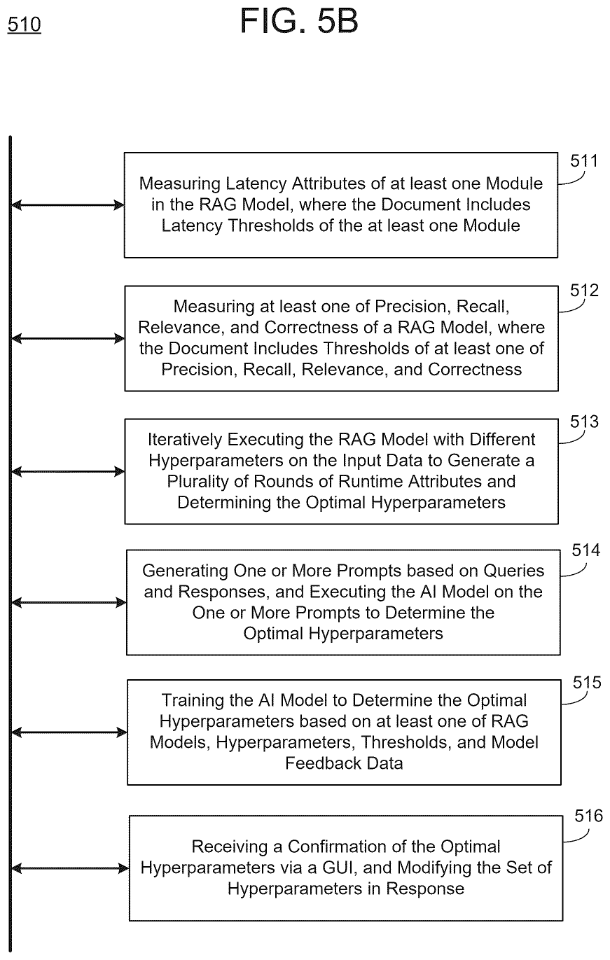

FIG. 5A illustrates a method 500 of recommending components for a retrieval augmented generation (RAG) model. For example, the method 500 may be performed by a host platform such as a cloud platform, a web server, a software application, a combination of systems, and the like. Referring to FIG. 5A, in 501, the method may include executing a retrieval augmented generation (RAG) model comprising a set of hyperparameters on input data to generate a predicted output via a software application. In 502, the method may include measuring runtime attributes of the RAG model based on at least one of the execution of the RAG model on the input data and the predicted output.

In 503, the method may include receiving a document that includes thresholds for the runtime attributes for the RAG model. In 504, the method may include executing an artificial intelligence (AI) model on the runtime attributes and the thresholds in the document to determine optimal hyperparameters for the RAG model. In 505, the method may include modifying the set of hyperparameters of the RAG model to include the optimal hyperparameters via the software application to generate a modified RAG model. In 506, the method may include executing the modified RAG model on a query to generate a response. For example, the modified RAG model may be executed on a new query and may be executed based on the modified hyperparameters. In this case, the response that is generated may be more accurate, be generated with less latency, etc. due to the optimal hyperparameters being implemented.

FIG. 5B illustrates a method 510 of identifying nearest neighbors from table data according to other examples and features of the instant solution. For example, the method 510 may be performed by a host platform such as a cloud platform, a web server, a software application, a combination of systems, and the like. Referring to FIG. 5B, in 511, the method may include measuring latency attributes for at least one of an embedding module, a retriever module, and an evaluator module of the RAG model, and the document may include latency thresholds for the at least one of the embedding module, the retriever module, and the evaluator module. In 512, the method may include measuring at least one of precision, recall, relevance, and factual correctness of the RAG model based on the predicted output, and the document may include thresholds for at least one of precision, recall, relevance, and factual correctness for the RAG model.

In some examples and features of the instant solution, in 513, the executing the RAG model may include iteratively executing the RAG model with different sets of hyperparameters on the input data to generate a plurality of rounds of runtime attributes, and executing the AI model on the plurality of rounds of runtime attributes to determine the optimal hyperparameters. In 514, the method may include generating and outputting one or more queries to a graphical user interface (GUI) of the software application, receiving one or more responses to the one or more queries via the GUI, and generating one or more prompts including the one or more queries combined with the one or more responses, respectively, and executing the AI model on the one or more prompts to determine the optimal hyperparameters.

In 515, the AI model may include a neural network capability, and the method may include training the AI model with the neural network capability to determine the optimal hyperparameters based on at least one of other RAG models, hyperparameters of the other RAG models, threshold requirements of the other RAG models, and model feedback data. In 516, the method may further include displaying the optimal hyperparameters for the RAG model via a graphical user interface (GUI) of the software application, receiving an input via the GUI which confirms the optimal hyperparameters, and modifying the set of hyperparameters of the RAG model to include the optimal hyperparameters in response to the input via the GUI.

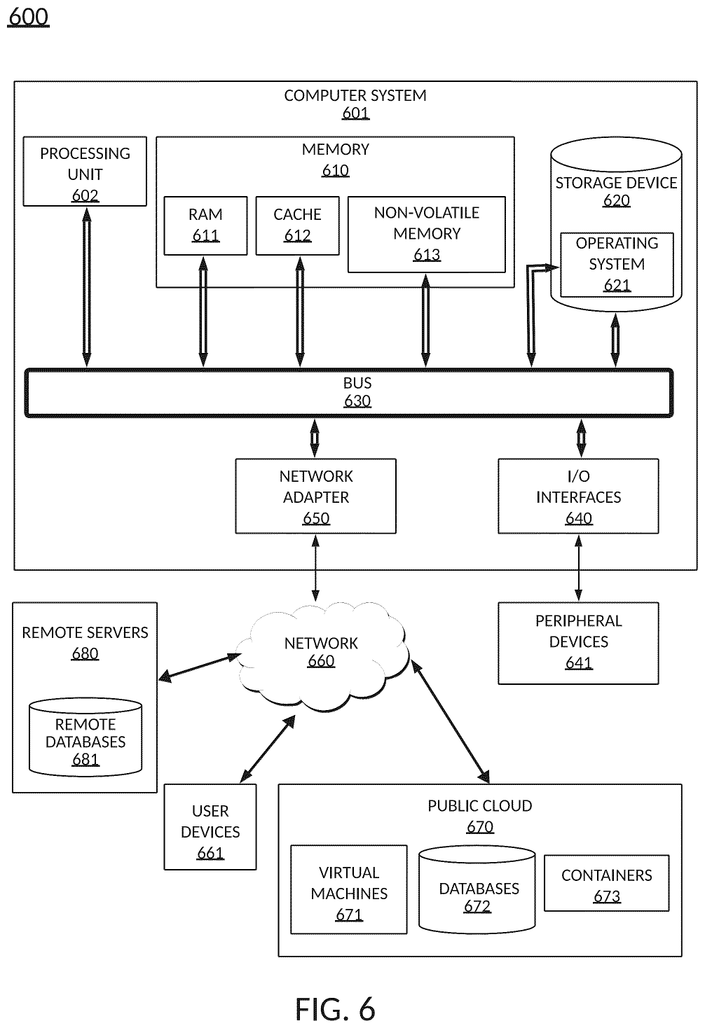

The examples and features of the instant solution may be implemented in one or more of the elements described or depicted herein, including for example, the elements described or depicted in FIG. 6. These examples and features may further be implemented in hardware, in a computer program executed by a processor, in firmware, or in a combination of the above. A computer program may be embodied on a computer readable medium, such as a storage medium. For example, a computer program may reside in random access memory (RAM), flash memory, read-only memory (ROM), erasable programmable read-only memory (EPROM), electrically erasable programmable read-only memory (EEPROM), registers, hard disk, a removable disk, a compact disk read-only memory (CD-ROM), or any other form of storage medium known in the art.

An exemplary storage medium may be communicatively coupled to the processor such that the processor may read information from, and write information to, the storage medium. In the alternative, the storage medium may be integral to the processor. The processor and the storage medium may reside in an application specific integrated circuit (ASIC). In the alternative, the processor and the storage medium may reside as discrete components. For example, FIG. 6 illustrates an example computer system architecture, which may represent or be integrated in any of the above-described components, etc.

FIG. 6 illustrates a computing environment according to the instant solution's example features, structures, or characteristics. FIG. 6 is not intended to suggest any limitation as to the scope of use or functionality of features, structures, or characteristics of the instant solution of the application described herein. Regardless, the computing environment 600 can be implemented to perform any of the functionalities described herein. In computing environment 600, there is a computer system 601, operational within numerous other general-purpose or special-purpose computing system environments or configurations.

Computer system 601 may take the form of a desktop computer, laptop computer, tablet computer, smartphone, smartwatch or other wearable computer, server computer system, thin client, thick client, network computer system, minicomputer system, mainframe computer, quantum computer, and distributed cloud computing environment that include any of the described systems or devices, and the like or any other form of computer or mobile device now known or to be developed in the future that is capable of running a program, accessing a network 660 or querying a database. Depending upon the technology, the performance of a computer-implemented method may be distributed among multiple computers and among multiple locations. However, in this presentation of the computing environment 600, a detailed discussion is focused on a single computer, specifically computer system 601, to keep the presentation as simple as possible.

Computer system 601 may be located in a cloud, even though it is not shown in a cloud in FIG. 6. On the other hand, computer system 601 may not be in a cloud except to any extent as may be affirmatively indicated. Computer system 601 may be described in the general context of computer system-executable instructions, such as program modules, executed by a computer system 601. Generally, program modules may include routines, programs, objects, components, logic, data structures, and so on that perform tasks or implement certain abstract data types. As shown in FIG. 6, computer system 601 in computing environment 600 is shown in the form of a general-purpose computing device. The components of computer system 601 may include but are not limited to, at least one processor or processing unit 602, a system memory 610, and a bus 630 that couples various system components, including system memory 610 to processing unit 602.

Processing unit 602 includes at least one computer processor of any type now known or to be developed. The processing unit 602 may contain circuitry distributed over multiple integrated circuit chips. The processing unit 602 may also implement multiple processor threads and multiple processor cores. Cache 612 is a memory that may be in the processor chip package(s) or located “off-chip,” as depicted in FIG. 6. Cache 612 is typically used for data or code accessed by the threads or cores running on the processing unit 602. In some computing environments, processing unit 602 may be designed to work with qubits and perform quantum computing.

Memory 610 is any volatile memory now known or to be developed in the future. Examples include dynamic random-access memory (RAM) 611 or static type RAM 611. Typically, the volatile memory is characterized by random access, but this may not be the characterization unless affirmatively indicated. In computer system 601, memory 610 is in a single package. It is internal to computer system 601, but alternatively or additionally, the volatile memory may be distributed over multiple packages and/or located externally with respect to computer system 601. By way of example, memory 610 can be provided for reading from and writing to a non-removable, non-volatile magnetic media (shown as storage device 620, and typically called a “hard drive”). Memory 610 may include at least one program product having a set (e.g., at least one) of program modules configured to carry out the functions of various features, structures, or characteristics of the instant solution of the application. A typical computer system 601 may include cache 612, a specialized volatile memory generally faster than RAM 611 and generally located closer to the processing unit 602. Cache 612 stores frequently accessed data and instructions accessed by the processing unit 602 to speed up processing time. The computer system 601 may also include non-volatile memory 613 in the form of ROM, PROM, EEPROM, and flash memory. Non-volatile memory 613 often contains programming instructions for starting the computer, including the basic input/output system (BIOS) and information to start the operating system 621.

Computer system 601 may include a removable/non-removable, volatile/non-volatile computer storage device 620. For example, storage device 620 can be a non-removable, non-volatile magnetic media (not shown and typically called a “hard drive”). At least one data interface can connect it to the bus 630. In features, structures, or characteristics of the instant solution where computer system 601 has a large amount of storage (for example, where computer system 601 locally stores and manages a large database), then this storage may be provided by peripheral storage devices 620 designed for storing very large amounts of data, such as a storage area network (SAN) that is shared by multiple, geographically distributed computers.

The operating system 621 is software that manages computer system 601 hardware resources and provides common services for computer programs. Operating system 621 may take several forms, such as various known proprietary operating systems or open-source Portable Operating System Interface type operating systems that employ a kernel.

The bus 630 represents at least one of several types of bus structures, including a memory bus or memory controller, a peripheral bus, an accelerated graphics port, and a processor or local bus using various bus architectures. By way of example, and not limitation, such architectures include Industry Standard Architecture (ISA) buses, Micro Channel Architecture (MCA) buses, Enhanced ISA (EISA) buses, Video Electronics Standards Association (VESA) local buses, and Peripheral Component Interconnect (PCI) bus. The bus 630 is the signal conduction path that allows the various components of computer system 601 to communicate.

Computer system 601 may communicate with at least one peripheral device, 641, via an input/output (I/O) interface, 640. Such devices may include a keyboard, a pointing device, a display, etc.; at least one device that enables a user to interact with computer system 601; and/or any devices (e.g., network card, modem, etc.) that enable computer system 601 to communicate with at least one other computing devices. Such communication can occur via I/O interface 640. As depicted, I/O interface 640 communicates with the other components of computer system 601 via bus 630.

Network adapter 650 enables the computer system 601 to connect and communicate with at least one network 660, such as a local area network (LAN), a wide area network (WAN), and/or a public network (e.g., the Internet). It bridges the computer's internal bus 630 and the external network, exchanging data efficiently and reliably. The network adapter 650 may include hardware, such as modems or Wi-Fi signal transceivers, and software for packetizing and/or de-packetizing data for communication network transmission. Network adapter 650 supports various communication protocols to ensure compatibility with network standards. Ethernet connections adhere to protocols such as IEEE 802.3, while wireless communications might support IEEE 802.11 standards, Bluetooth, near-field communication (NFC), or other network wireless radio standards.

Network 660 is any computer network that can receive and/or transmit data. Network 660 can include a WAN, LAN, private cloud, or public Internet, capable of communicating computer data over non-local distances by any technology that is now known or to be developed in the future. Any connection depicted can be wired and/or wireless and may traverse other components that are not shown. In some features, structures, or characteristics of the instant solution, a network 660 may be replaced and/or supplemented by LANs designed to communicate data between devices in a local area, such as a Wi-Fi network. The network 660 typically includes computer hardware such as copper transmission cables, optical transmission fibers, wireless transmission, routers, firewalls, switches, gateway computers, edge servers, and network infrastructure known now or to be developed in the future. Computer system 601 connects to network 660 via network adapter 650 and bus 630.

User devices 661 are any computer systems used and controlled by an end user in connection with computer system 601. For example, in a hypothetical case where computer system 601 is designed to provide a recommendation to an end user, this recommendation may typically be communicated from network adapter 650 of computer system 601 through network 660 to a user device 661, allowing user device 661 to display, or otherwise present, the recommendation to an end user. User devices can be a wide array, including personal computers, laptops, tablets, hand-held, mobile phones, etc.

A public cloud 670 is an on-demand availability of computer system resources, including data storage and computing power, without direct active management by the user. Public clouds 670 are often distributed, with data centers in multiple locations for availability and performance. Computing resources on public clouds 670 are shared across multiple tenants through virtual computing environments comprising virtual machines 671, databases 672, containers 673, and other resources. A container 673 is an isolated, lightweight software for running a software application on the host operating system 621. Containers 673 are built on top of the host operating system's kernel and contain software applications and some lightweight operating system APIs and services. In contrast, virtual machine 671 is a software layer with an operating system 621 and kernel. Virtual machines 671 are built on top of a hypervisor emulation layer designed to abstract a host computer's hardware from the operating software environment. Public clouds 670 generally offers databases 672, abstracting high-level database management activities. At least one element described or depicted in FIG. 6 can perform at least one of the actions, functionalities, or features described or depicted herein.

Remote servers 680 are any computers that serve at least some data and/or functionality over a network 660, for example, WAN, a virtual private network (VPN), a private cloud, or via the Internet to computer system 601. These networks 660 may communicate with a LAN to reach users. The user interface may include a web browser or a software application that facilitates communication between the user and remote data. Such software applications have been referred to as “thin” desktop software applications or “thin clients.” Thin clients typically incorporate software programs to emulate desktop sessions. Mobile device software applications can also be used. Remote servers 680 can also host remote databases 681, with the database located on one remote server 680 or distributed across multiple remote servers 680. Remote databases 681 are accessible from database client applications installed locally on the remote server 680, other remote servers 680, user devices 661, or computer system 601 across a network 660. An AI/ML model described or depicted here may reside fully or partially on any of the elements described or depicted in FIG. 6.

Although an exemplary example of the instant solution of at least one of an apparatus, method, and computer readable medium has been illustrated in the accompanying drawings and described in the foregoing detailed description, it will be understood that the instant solution is not limited to the examples of the instant solution disclosed but is capable of numerous rearrangements, modifications, and substitutions as set forth and defined by the following claims. For example, the instant solution's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that the instant solution may be embodied as a personal computer, a server, a console, a personal digital assistant (PDA), a cell phone, a tablet computing device, a smartphone, or any other suitable computing device, or combination of devices. Presenting the above-described functions as being performed by the instant solution is not intended to limit the scope of the present instant solution in any way but is intended to provide one example of the many examples of the instant solution. Indeed, methods, systems, and apparatuses disclosed herein may be implemented in localized and distributed forms consistent with computing technology.

It should be noted that some of the instant solution features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module may not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory, tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the instant solution, as generally described and illustrated in the figures herein, may be arranged and designed in a wide variety of different configurations. Thus, the detailed descriptions of the instant solution and the examples and features of the instant solution are not intended to limit the scope of the instant solution as claimed but are merely representative examples of the instant solution.

One having ordinary skill in the art will readily understand that the above may be practiced with steps in a different order and/or with hardware elements in configurations that are different from those which are disclosed. Therefore, although the instant solution has been described based upon these preferred examples and features of the instant solution, it would be apparent to those of skill in the art that certain modifications, variations, and alternative constructions would be apparent.

While preferred examples of the present instant solution have been described, it is to be understood that the examples described are illustrative only, and the scope of the instant solution is to be defined solely by the appended claims when considered with a full range of equivalents and modifications (e.g., protocols, hardware devices, software platforms, etc.) thereto.

What is claimed is:

1. An apparatus, comprising:
a memory configured to store a retrieval-augmented generation (RAG) model comprising a set of hyperparameters; and
a processor coupled to the memory, the processor configured to:
execute the RAG model on input data to generate a predicted output via a software application,
measure runtime attributes of the RAG model based on at least one of execution of the RAG model on the input data and the predicted output,
receive a document that includes thresholds for the runtime attributes for the RAG model,
execute an artificial intelligence (AI) model on the runtime attributes and the thresholds in the document to determine optimal hyperparameters for the RAG model,
modify the set of hyperparameters of the RAG model to include the optimal hyperparameters via the software application to generate a modified RAG model, and
execute the modified RAG model on a query to generate a response.

2. The apparatus of claim 1, wherein the processor is configured to measure latency attributes for at least one of an embedding module, a retriever module, and an evaluator module of the RAG model, and the document comprises latency thresholds for the at least one of the embedding module, the retriever module, and the evaluator module.

3. The apparatus of claim 1, wherein the processor is configured to measure at least one of precision, recall, relevance, and factual correctness of the RAG model based on the predicted output, and the document comprises thresholds for at least one of precision, recall, relevance, and factual correctness for the RAG model.

4. The apparatus of claim 1, wherein the processor is configured to iteratively execute the RAG model with different sets of hyperparameters on the input data to generate a plurality of rounds of runtime attributes, and execute the AI model on the plurality of rounds of runtime attributes to determine the optimal hyperparameters.

5. The apparatus of claim 1, wherein the processor is further configured to generate and output one or more queries to a graphical user interface (GUI) of the software application, receive one or more responses to the one or more queries via the GUI, generate one or more prompts including the one or more queries combined with the one or more responses, respectively, and execute the AI model on the one or more prompts to determine the optimal hyperparameters.

6. The apparatus of claim 1, wherein the AI model comprises a neural network capability, and the processor is further configured to train the AI model with the neural network capability to determine the optimal hyperparameters based on at least one of other RAG models, hyperparameters of the other RAG models, threshold requirements of the other RAG models, and model feedback data.

7. The apparatus of claim 1, wherein the processor is further configured to display the optimal hyperparameters for the RAG model via a graphical user interface (GUI) of the software application, receive an input via the GUI which confirms the optimal hyperparameters, and modify the set of hyperparameters of the RAG model to include the optimal hyperparameters in response to the input via the GUI.

8. A method comprising:
executing a retrieval-augmented generation (RAG) model comprising a set of hyperparameters on input data to generate a predicted output via a software application;
measuring runtime attributes of the RAG model based on at least one of execution of the RAG model on the input data and the predicted output;
receiving a document that includes thresholds for the runtime attributes for the RAG model;
executing an artificial intelligence (AI) model on the runtime attributes and the thresholds in the document to determine optimal hyperparameters for the RAG model;
modifying the set of hyperparameters of the RAG model to include the optimal hyperparameters via the software application to generate a modified RAG model; and
executing the modified RAG model on a query to generate a response.

9. The method of claim 8, wherein the measuring comprises measuring latency attributes for at least one of an embedding module, a retriever module, and an evaluator module of the RAG model, and the document comprises latency thresholds for the at least one of the embedding module, the retriever module, and the evaluator module.

10. The method of claim 8, wherein the measuring comprises measuring at least one of precision, recall, relevance, and factual correctness of the RAG model based on the predicted output, and the document comprises thresholds for at least one of precision, recall, relevance, and factual correctness for the RAG model.

11. The method of claim 8, wherein the executing the RAG model comprises iteratively executing the RAG model with different sets of hyperparameters on the input data to generate a plurality of rounds of runtime attributes, and the executing the AI model comprises executing the AI model on the plurality of rounds of runtime attributes to determine the optimal hyperparameters.

12. The method of claim 8, further comprising generating and outputting one or more queries to a graphical user interface (GUI) of the software application, receiving one or more responses to the one or more queries via the GUI, and generating one or more prompts including the one or more queries combined with the one or more responses, respectively, wherein the executing the AI model comprises executing the AI model on the one or more prompts to determine the optimal hyperparameters.

13. The method of claim 8, wherein the AI model comprises a neural network capability, and the method further comprises training the AI model with the neural network capability to determine the optimal hyperparameters based on at least one of other RAG models, hyperparameters of the other RAG models, threshold requirements of the other RAG models, and model feedback data.

14. The method of claim 8, further comprising displaying the optimal hyperparameters for the RAG model via a graphical user interface (GUI) of the software application, receiving an input via the GUI which confirms the optimal hyperparameters, and modifying the set of hyperparameters of the RAG model to include the optimal hyperparameters in response to the input via the GUI.

15. A computer-readable storage medium comprising instructions which when executed by a computer cause a processor to perform:
executing a retrieval-augmented generation (RAG) model comprising a set of hyperparameters on input data to generate a predicted output via a software application;
measuring runtime attributes of the RAG model based on at least one of execution of the RAG model on the input data and the predicted output,
receiving a document that includes thresholds for the runtime attributes for the RAG model;
executing an artificial intelligence (AI) model on the runtime attributes and the thresholds in the document to determine optimal hyperparameters for the RAG model;
modifying the set of hyperparameters of the RAG model to include the optimal hyperparameters via the software application to generate a modified RAG model; and
executing the modified RAG model on a query to generate a response.

16. The computer-readable storage medium of claim 15, wherein the measuring comprises measuring latency attributes for at least one of an embedding module, a retriever module, and an evaluator module of the RAG model, and the document comprises latency thresholds for the at least one of the embedding module, the retriever module, and the evaluator module.

17. The computer-readable storage medium of claim 15, wherein the measuring comprises measuring at least one of precision, recall, relevance, and factual correctness of the RAG model based on the predicted output, and the document comprises thresholds for at least one of precision, recall, relevance, and factual correctness for the RAG model.

18. The computer-readable storage medium of claim 15, wherein the executing the RAG model comprises iteratively executing the RAG model with different sets of hyperparameters on the input data to generate a plurality of rounds of runtime attributes, and the executing the AI model comprises executing the AI model on the plurality of rounds of runtime attributes to determine the optimal hyperparameters.

19. The computer-readable storage medium of claim 15, wherein the processor is further configured to perform generating and outputting one or more queries to a graphical user interface (GUI) of the software application, receiving one or more responses to the one or more queries via the GUI, and generating one or more prompts including the one or more queries combined with the one or more responses, respectively, wherein the executing the AI model comprises executing the AI model on the one or more prompts to determine the optimal hyperparameters.

20. The computer-readable storage medium of claim 15, wherein the AI model comprises a neural network capability, and the processor is further configured to perform training the AI model with the neural network capability to determine the optimal hyperparameters based on at least one of other RAG models, hyperparameters of the other RAG models, threshold requirements of the other RAG models, and model feedback data.
